(19) United States
(12) Patent Application Publication
(10) Pub. No.: US 2020/0409233 A1
(43) Pub. Date: Dec. 31, 2020

(54) LENS ASSEMBLY

(71) Applicant: AAC Optics Solutions Pte. Ltd., Singapore city (SG)

(72) Inventor: Jarno Matikainen, Finland City (FI)

(21) Appl. No.: 16/726,174

(22) Filed: Dec. 23, 2019

(30) Foreign Application Priority Data
Jun. 27, 2019 (CN) 201920986409.3

(51) Int. Cl. G03B 5/02; G02B 5/20; G03B 11/00; G02B 27/64

(52) U.S. Cl. CPC G03B 5/02; G02B 5/208; G03B 2205/0015; G02B 27/646; G03B 11/00

(57) ABSTRACT

The present disclosure provides a lens assembly, including a housing having a receiving space and including a base and a shell that is assembled with the base to form the receiving space, an optical lens received in the receiving space, an anti-jitter mechanism including a driving member, and an anti-jitter bracket; an imaging sensor; and an infrared filter. The anti-jitter bracket includes a support member arranged opposite to and spaced apart from the base. The support member is provided with a light-transmitting window corresponding to the optical lens. The infrared filter covers the light-transmitting window. The infrared filter and the support member are formed into one piece. Compared with the lens in the related art, the present lens assembly can directly arrange the infrared filter on the anti-jitter bracket without additionally providing a mounting member especially for mounting the infrared filter, thereby simplifying the overall structure of the lens assembly.

### TECHNICAL FIELD

The present disclosure relates to the field of lens technology, and in particular, to a lens assembly.

### BACKGROUND

OIS (Optical Image Stabilization) refers to provision of optical components in a camera or other similar imaging instruments, such as provision of a lens, in order to avoid or reduce instrument jitter that occurs in the process of capturing optical signals, thereby improving image quality.

An OIS lens in the related art generally has an infrared filter, and the infrared filter is mounted in front of an image sensor, to prevent infrared rays from passing and resulting in image distortion. When mounting and providing an infrared filter in the OIS lens in the related art, the infrared filter is usually mounted by separately and additionally providing a mounting member. However, such a structure will cause an overall structure of the OIS lens to be complicated.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an overall structural schematic diagram of a lens assembly provided by an embodiment of the present disclosure;

FIG. 2 is a longitudinal cross-sectional diagram of a center of FIG. 1;

FIG. 3 is a partial enlarged diagram of a portion I of FIG. 2;

FIG. 4 is a structural schematic diagram of an anti-jitter bracket provided by an embodiment of the present disclosure;

FIG. 5 is a longitudinal cross-sectional diagram of FIG. 4;

FIG. 6 is a longitudinal cross-sectional diagram of a side portion of a lens assembly provided by an embodiment of the present disclosure.

### REFERENCE NUMERICAL

1—anti-jitter bracket;
   11—support member;
      111—light-transmitting window;
      112—annular retaining rim;
   12—support portion;
   13—fixing portion;
2—infrared filter;
3—optical lens;
4—lens barrel;
5—base;
6—housing;
7—magnet;
8—coil;
9—imaging sensor;
H—optical axis direction.

### DESCRIPTION OF EMBODIMENTS

The present disclosure will be further illustrated with reference to the accompanying drawings and the embodiments.

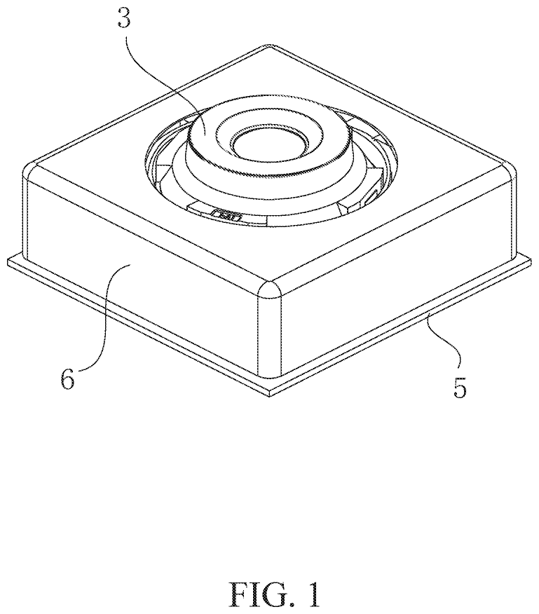

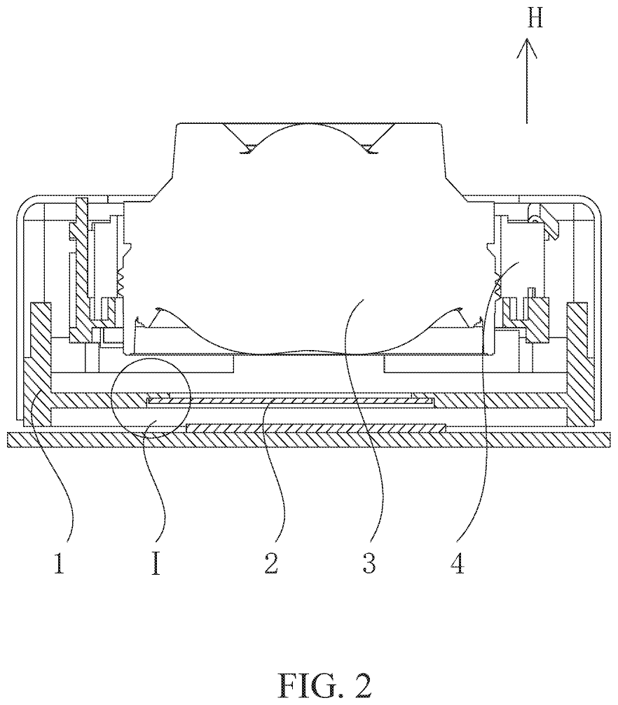

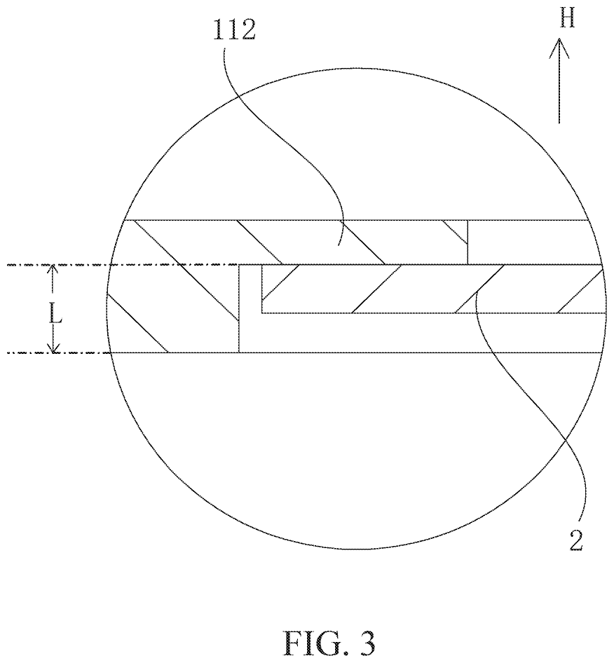

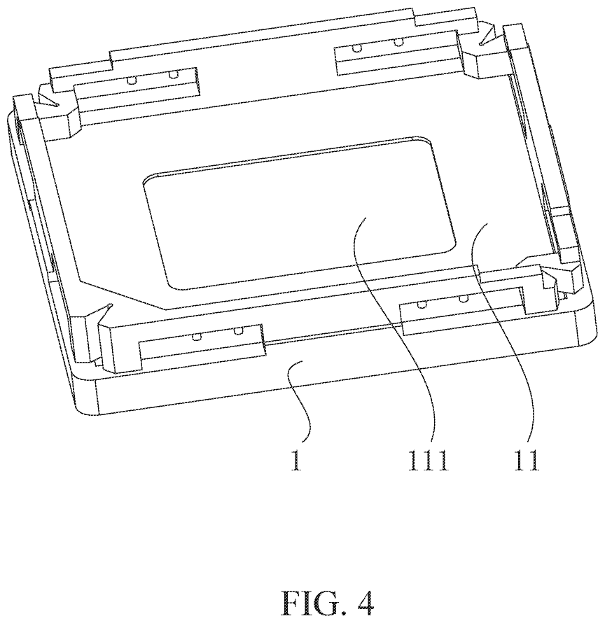

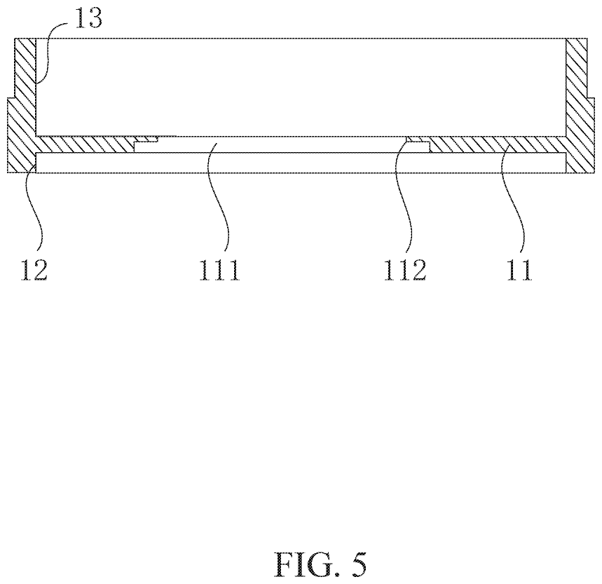

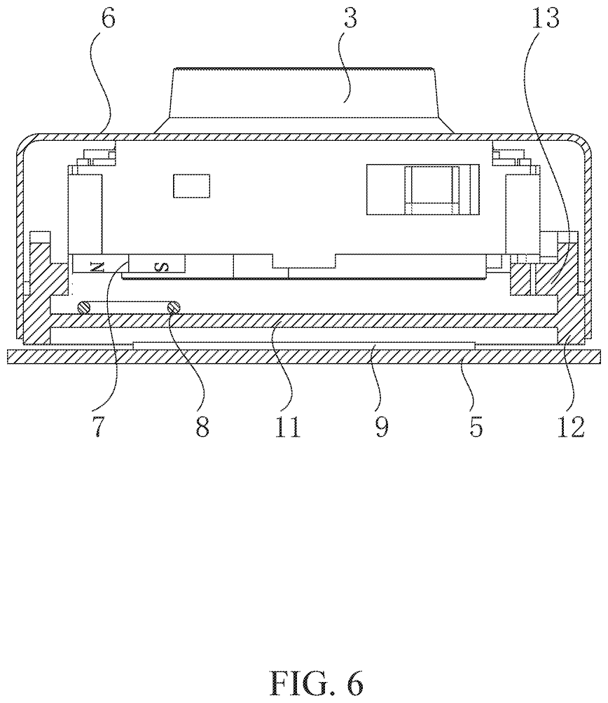

FIG. 1 is an overall structural schematic diagram of a lens assembly provided by an embodiment of the present disclosure; FIG. 2 is a longitudinal cross-sectional diagram of FIG. 1; FIG. 3 is a partial enlarged diagram of a portion I of FIG. 2; FIG. 4 is a structural schematic diagram of an anti-jitter bracket provided by an embodiment of the present disclosure; FIG. 5 is a longitudinal cross-sectional diagram of FIG. 4; and FIG. 6 is a longitudinal cross-sectional diagram of a side portion of a lens assembly provided by an embodiment of the present disclosure.

As shown in FIG. 1 and FIG. 2, an embodiment of the present disclosure provides a lens assembly. The lens assembly includes a housing having a receiving space, an optical lens 3 received in the receiving space, and an anti-jitter mechanism driving the optical lens 3 to move along a direction perpendicular to an optical axis direction H of the optical lens 3.

The housing includes a base 5 and a shell that is assembled with the base 5 to form the receiving space. The anti-jitter mechanism includes a driving member fixed to the optical lens 3, and an anti-jitter bracket 1 fixed to the housing and interacting with the driving member.

The anti-jitter bracket 1 includes a support member 11 arranged opposite to and spaced apart from the base 5. The support member 11 is provided with a light-transmitting window 111 corresponding to the optical lens 3. The lens assembly further includes an imaging sensor 9 fixed on the base 5, and an infrared filter covering the light-transmitting window 111. The infrared filter and the support member 11 are formed into one piece.

The lens assembly can have the infrared filter 2 directly arranged on the anti-jitter bracket 1 without additionally providing a mounting member especially for mounting the infrared filter 2, thereby simplifying the overall structure of the lens assembly. Moreover, the infrared filter and the support member 11 are formed into one piece, so that when providing the infrared filter, the infrared filter can be directly placed in a mold of the support member 11 and then the two are directly injection molded into one piece without other bonding process, which simplifies the processing process.

In an alternative aspect of the present disclosure, the annular retaining rim 112 is disposed on the peripheral wall of the support member 11 forming the light-transmitting window 111, and the infrared filter 2 and the annular retaining rim 112 are formed into one piece.

Specifically, as shown in FIG. 2 and FIG. 5, the annular retaining rim 112 is provided to facilitate that the infrared filter 2 covers the light-transmitting window 111. When providing the infrared filter 2, the infrared filter 2 can be directly placed on the molding mold of the annular retaining rim 112, and then the two are directly injection molded into one piece without other bonding process.

However, the present disclosure is not limited thereto. The annular retaining rim 112 can be omitted, and instead, the infrared filter 2 can also be normally mounted by configuring a size of the infrared filter 2 to be slightly larger than that of the light-transmitting window 111 and bonding, with an adhesive, the infrared filter 2 to the support member 11 so as to cover the light-transmitting window 111.

In an alternative aspect of the present embodiment, the infrared filter is provided on a side of the annular retaining rim 112 facing away from the optical lens 3.

Such a structure can increase a distance between the infrared filter and the optical lens 3, thereby making it possible to prevent the infrared filter 2 from being pushed and damaged by the optical lens 3 when the infrared filter 2 is mounted to the optical lens 3 together with the anti-jitter bracket 1, and to prevent the optical lens 3 from accidentally touching and damaging the infrared filter 2 when the optical lens 3 performs the anti-jitter function under the driving of a driving member.

In an alternative aspect of the present embodiment, in the optical axis direction H, a distance between the side of the annular retaining rim 112 facing away from the optical lens 3 and the side of the support member 11 facing away from the optical lens 3 is greater than or equal to the thickness of the infrared filter 2.

Specifically, as shown in FIG. 3, the distance between the side of the annular retaining rim 112 facing away from the optical lens 3 and the side of the support member 11 facing away from the optical lens 3 is denoted as L, and the distance L is configured to be greater than or equal to the thickness of the infrared filter 2, so that it can be achieved that the infrared filter 2 is completely received in the light-transmitting window 111. The infrared filter 2 is mounted in front of the image sensor, thereby making it possible to prevent the infrared filter 2 from being pushed and damaged by the image sensor when the infrared filter 2 is mounted in front of the image sensor together with the anti-jitter bracket 1.

In an alternative aspect of the present embodiment, the anti-jitter bracket 1 includes a fixing portion 13 fixed to the shell. The fixing portion 13 extends from an edge of the support member 11 while being bent towards the shell and surrounds the support member 11.

Specifically, as shown in FIG. 5, the fixing portion 13 surrounds the peripheral edge portion where the support member 11 is provided, such that the shell can be fully buckled on the support member 11, which not only can increase the mounting robustness of the two, but can also cause the shell to sufficiently block the light so as to prevent the external light from irradiating the image sensor, thereby achieving the imaging effect of the image sensor.

In an alternative aspect of the present embodiment, the support member 11 is spaced apart from the base 5. The anti-jitter bracket 1 further includes a support portion 12 that extends from the edge of the support member 11 while being bent towards the base 5. The support portion 12 and the fixing portion 13 are respectively located on two sides of the support member 11.

Specifically, as shown in FIG. 5, the support portion 12 is provided to enable the infrared filter 2 to be spaced apart from and above the image sensor. Thus, when the infrared filter 2 is mounted with the anti-jitter bracket 1, it is always achieved that there is a certain safety distance between the infrared filter 2 and the image sensor, thereby preventing the infrared filter 2 from being accidentally damaged when being mounted.

In an alternative aspect of the present embodiment, the support member 11, the support portion 12 and the fixing portion 13 are formed into one piece.

Forming the mounting portion, the support portion 12 and the fixing portion 13 into one piece can facilitate the processing and fabrication. Specifically, an integral mold can be adopted for performing direct injection molding, to reduce the fabrication cost of the anti-jitter bracket 1.

Without doubt, the support member 11, the support portion 12 and the fixing portion 13 may be individually fabricated by separate molding, and then combined into the anti-jitter bracket 1 by bonding.

In an alternative aspect of the present embodiment, the imaging sensor 9 is spaced apart from the support member 11.

Since the infrared filter 2 covers the light-transmitting window 111 provided in the support member 11, spacing the imaging sensor 9 from the support member 11 can prevent contact between the imaging sensor 9 and the support member 11 or the infrared filter 2 during mounting or use, which would otherwise lead to damage.

In an alternative aspect of the present embodiment, the optical lens 3 includes a lens barrel 4 and a lens group received in the lens barrel 4, and a driving member is fixed to the lens barrel 4.

When the lens assembly generates a movement amount perpendicular to the optical axis direction H due to being subjected to an external vibration, the driving member can drive the optical lens 3 to generate a compensation movement amount that cancels out the external jitter, so as to maintain the optical path stable, thereby effectively overcoming image blur caused by the external vibration and improving the imaging quality.

In an alternative aspect of the present embodiment, the driving member includes a magnet 7 fixed to the lens barrel 4 and a coil 8 fixed to the anti-jitter bracket 1. The magnet 7 interacts with the coil 8 to drive the optical lens 3 to move, by a movement amount for cancelling out the external jitter, along a direction perpendicular to the optical axis direction H.

Driving the optical lens 3 to generate the compensation movement amount for cancelling out the external jitter is achieved by the magnetic force of the interaction between the magnet 7 and the coil 8, and the response is quick and the compensation precision of the movement amount is high. Specifically, a gyroscope in the lens assembly detects a slight movement and transfers the detected information to a microprocessor. The microprocessor immediately calculates the displacement amount required to be compensated and generates a response current to the coil 8. An electromagnetic force is generated between the coil 8 and the magnet 7 in response to the current, to drive the optical lens 3 to move, thereby maintaining the optical path stable and improving the imaging quality.

The above is only a preferred embodiment of the present disclosure and is not used to limit the present disclosure. Any modifications, equivalent substitutions, improvements, etc., which are made within the spirit and principles of the present disclosure, should be included in scope of the present disclosure.

What is claimed is:

1. A lens assembly, comprising:
a housing having a receiving space and comprising a base and a shell that is assembled with the base to form the receiving space;
an optical lens received in the receiving space;
an anti-jitter mechanism configured to drive the optical lens to move in a direction perpendicular to an optical axis direction of the optical lens, and comprising a driving member fixed to the optical lens, and an anti-jitter bracket fixed to the housing and interacting with the driving member;
an imaging sensor fixed to the base; and
an infrared filter,
wherein the anti-jitter bracket comprises a support member arranged opposite to and spaced apart from the base, the support member is provided with a light-transmitting window corresponding to the optical lens, the infrared filter covers the light-transmitting window, and the infrared filter and the support member are formed into one piece.

2. The lens assembly as described in claim 1, wherein an annular retaining rim is provided on a peripheral wall of the support member forming the light-transmitting window;
the infrared filter and the annular retaining rim are formed into one piece.

3. The lens assembly as described in claim 2, wherein the infrared filter is provided on a side of the annular retaining rim facing away from the optical lens.

4. The lens assembly as described in claim 3, wherein, in the optical axis direction, a distance between the side of the annular retaining rim facing away from the optical lens and a side of the support member facing away from the optical lens is greater than or equal to a thickness of the infrared filter.

5. The lens assembly as described in claim 1, wherein the anti-jitter bracket further comprises a fixing portion fixed to the shell;
the fixing portion extends from an edge of the support member while being bent towards the shell and surrounds the support member.

6. The lens assembly as described in claim 5, wherein the support member is spaced apart from the base, the anti-jitter bracket further comprises a support portion extending from the edge of the support member while being bent towards the base, and the support portion and the fixing portion are respectively located on two sides of the support member.

7. The lens assembly as described in claim 6, wherein the support member, the support portion and the fixing portion are formed into one piece.

8. The lens assembly as described in claim 1, wherein the imaging sensor is spaced apart from the support member.

9. The lens assembly as described in claim 1, wherein the optical lens comprises a lens barrel and a lens group received in the lens barrel, and the driving member is fixed to the lens barrel.

10. The lens assembly as described in claim 9, wherein the driving member comprises a magnet fixed to the lens barrel and a coil fixed to the anti-jitter bracket, and the magnet interacts with the coil to drive the optical lens to move, by a movement amount for cancelling out external jitter, along the direction perpendicular to the optical axis direction.
